(19) United States
(12) Patent Application Publication
(10) Pub. No.: US 2026/0146483 A1
(43) Pub. Date: May 28, 2026

(54) DOOR HANDLE ASSEMBLY FOR A VEHICLE DOOR INCLUDING A SENSOR MODULE

(71) Applicant: MINEBEA ACCESSSOLUTIONS ITALIA S.P.A., Pianezza (IT)

(72) Inventors: Nicolas MAZZEO, Pianezza (IT); Paul DORIN, Pianezza (IT); Mara SACCO, Pianezza (IT)

(73) Assignee: MINEBEA ACCESSSOLUTIONS ITALIA S.P.A., Pianezza (IT)

(21) Appl. No.: 19/402,328

(22) Filed: Nov. 26, 2025

(30) Foreign Application Priority Data
Nov. 27, 2024 (EP) 24215878.0

(51) Int. Cl. E05B 81/76

(52) U.S. Cl. CPC E05B 81/77

(57) ABSTRACT

A door handle assembly for a vehicle includes a grip member body and a sensor module. The sensor module includes a casing in which at least one sensor is housed and a wire harness connecting the at least one sensor to an external connector. The casing of the sensor module is an elongated shape along a longitudinal direction. The grip member body includes a recess for receiving the casing of the sensor module. The recess is provided on a first side of the grip member body. The recess communicates with an opening provided on a second side of the grip member body opposite to the first side. The opening is configured to allow the wire harness passing through the opening from one side of the grip member body to another. The opening is further configured to allow inserting the casing of the sensor module and to prevent inserting the connector.

### CROSS-REFERENCE TO RELATED APPLICATIONS

This application claims priority to and the benefit of EP 24215878.0 filed on November 27, 2024, the disclosure of which is incorporated herein by reference.

### FIELD

The present disclosure relates generally to vehicles and, more particularly, to a door handle assembly for a vehicle, the handle assembly including a sensor module.

### BACKGROUND

The statements in this section merely provide background information related to the present disclosure and may not constitute prior art.

Handle assemblies for vehicle doors generally comprise a handle, or grip member, a bracket to which the handle is secured and mechanical and/or electronic means configured to unlock the vehicle door and to activate a latch to open the vehicle door.

Handle assemblies are now equipped with one or several sensors located within the grip member, and the assembling of these electronic components with the grip member may be complex and time-consuming.

However, the handles assemblies are becoming more and more complex, and the grip members include more and more electronic components with associated connectors, which renders difficult to integrate the connector(s) within the grip member. It may therefore be easier to integrate the connector(s) within the handle assembly, in the vicinity of the grip member.

However, locating the connector(s) outside the grip member can render more complex the disassembling of the grip member from the outside of the vehicle, that is, without disassembling the inner door panel.

### SUMMARY

This section provides a general summary of the disclosure and is not a comprehensive disclosure of its full scope or all of its features.

An object of the invention is to provide a handle assembly having a grip member which can be disassembled from the outside of the vehicle, even when a connector connecting the electronic components is located outside from the grip member.

To this end, the invention relates to a door handle assembly for a vehicle, comprising a grip member body and a sensor module. The sensor module includes a casing in which at least one sensor is housed and a wire harness connecting the sensor to an external connector, the casing of the sensor module being elongated along a longitudinal direction. The grip member body includes a recess for receiving the casing of the sensor module, the recess being provided on a first side of the grip member body, the recess communicating with an opening provided on a second side of the grip member body opposite to the first side. The opening being configured to allow the wire harness passing through the opening from one side of the grip member body to another. The opening being further configured to allow inserting the casing of the sensor module and to prevent inserting the connector.

According to the invention, the casing of the sensor module, which is to be located within the recess on a first side of the grip member body, can be passed through the opening provided in the grip member body from a second side to the first side of the grip member body. It is advantageous that the opening provided in the grip member is just large enough for passing the casing of the sensor module but too small for passing the passing the external connector of the sensor module, because the smaller the opening is, the less it degrades the mechanical strength of the handle. The grip member body of the door handle assembly can therefore be easily assembled with the sensor module, without impairing the mechanical strength of the assembly.

The door handle assembly may comprise the following features, considered either alone or in any technically possible combination:

The recess provided in the grip member body has a generally rectangular shape.

A length of the opening is greater than a width of the casing of the sensor module and is less than a width of the connector of the sensor module.

A width of the opening is greater than a thickness of the casing of the sensor module.

The casing of the sensor module is secured to the grip member body by a detachable snap-in connection.

A notch is provided in the vicinity of the opening to secure the wire harness of the sensor module.

The invention also relates to a method for assembling a door handle assembly as disclosed above, the method including the following steps: passing the casing of the sensor module and a part of the wire harness through the opening, from the second side of the grip member body to the first side; and locating the casing of the sensor module within the recess of the central portion of the grip member body.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a perspective view of a grip member body according to the invention.

FIG. 2 is a top elevation view of the grip member body of FIG. 1.

FIG. 3 is a bottom elevation view of the grip member body of FIG. 1.

FIG. 4 is a perspective view of a sensor module according to the invention.

FIG. 5 is a perspective view of the assembly of the grip member body and of the sensor module according to the invention.

FIG. 6 is a detailed view of the grip member body showing the through opening

FIG. 7 illustrates the steps of assembling the sensor module within the grip member body.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

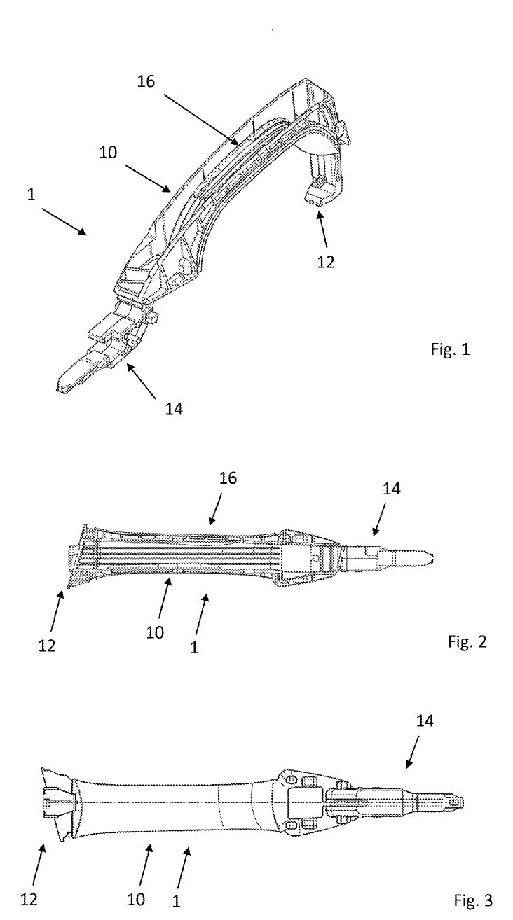

FIGS. 1 to 3 illustrate a grip member body 1 of a door handle assembly according to the invention.

The body 1 of the grip member according to the invention has a general U-shape and includes a central portion 10 designed to be grabbed by a user, and includes a first and a second connecting members 12, 14 configured to be fastened to a bracket of the handle assembly (not shown).

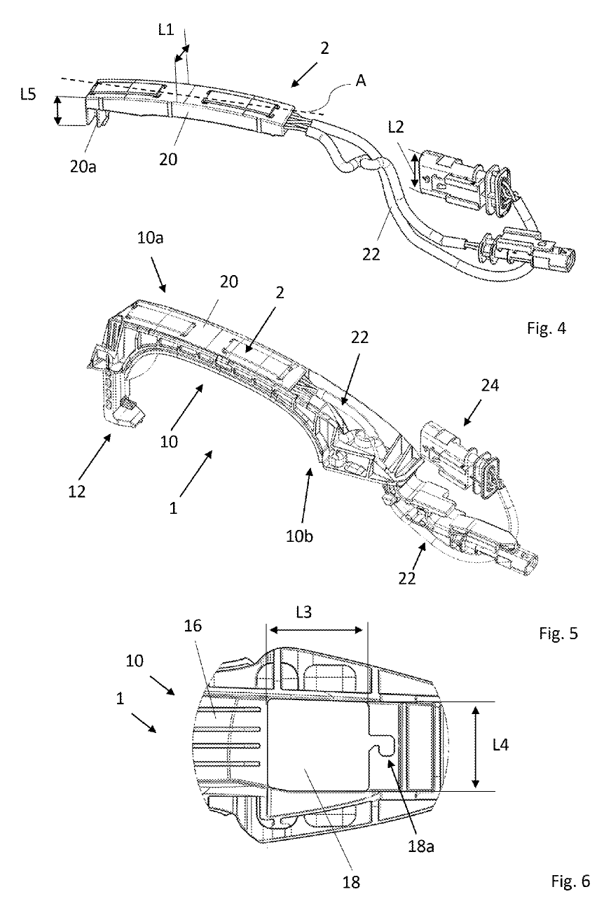

The central portion 10 of the body 1 includes a recess 16 extending along the length of the body 1. The recess 16 is configured for receiving a sensor module according to the invention, like the sensor module 2 shown in FIG. 4.

The sensor module 2 includes a casing 20 in which one or several sensors are housed, the sensors being for example configured for receiving a signal from a user's key in order to unlock a latch associated with the vehicle door handle assembly and/or configured for detecting a user's hand grabbing the handle. The casing 20 has a general elongated shape along a longitudinal direction A.

The sensor module 2 includes a wire harness 22 connecting the sensor(s) to an external connector 24.

The casing 20 has a general elongated shape along the longitudinal direction A, a width L1 of the casing 20 being lower than a width L2 of the connector 24.

As shown in FIGS. 1 and 2, the recess 16 of the body 1 of the grip member forms an open cavity within a first side 10a of the central portion of the body 1. The shape of the recess 16 is complementary to that of the casing 20 of the sensor module.

According to the invention, the recess 16 communicates with a through opening 18 formed within the central portion 10 of the body 1 of the grip member.

As shown in FIG. 6, the through opening 18 has a general rectangular shape and is configured to allow the casing 20 of the sensor module 2 to be inserted therein. The through opening 18 is further configured to prevent the connector 24 from being inserted therein. The configuration of the opening 18 therefore allows passing the casing 20 of the sensor module 2 from one side 10b of the body 1 to the other side 10a, while preventing the same action with the connector 24. In other words, the dimensions of the opening 18 are compatible with the insertion of the casing 2 of the sensor module 2 (and of the wire harness 22), but are not compatible with the insertion of the connector 24. In particular, the length L3 of the opening 18 is greater than a width L1 of the casing 20 of the sensor module 2, and is less than a width L2 of the connector 24 of the sensor module 2. A width L4 of the opening 18 is greater than a thickness L5 of the casing 20 of the sensor module 2.

The configuration of the opening 18 allows the mounting of the sensor module 2 while being as small as possible, so as not to impair the mechanical strength of the body 1 of the grip member.

A notch 18a may be provided in the vicinity of the opening 18, the notch being configured to secure the wire harness 22.

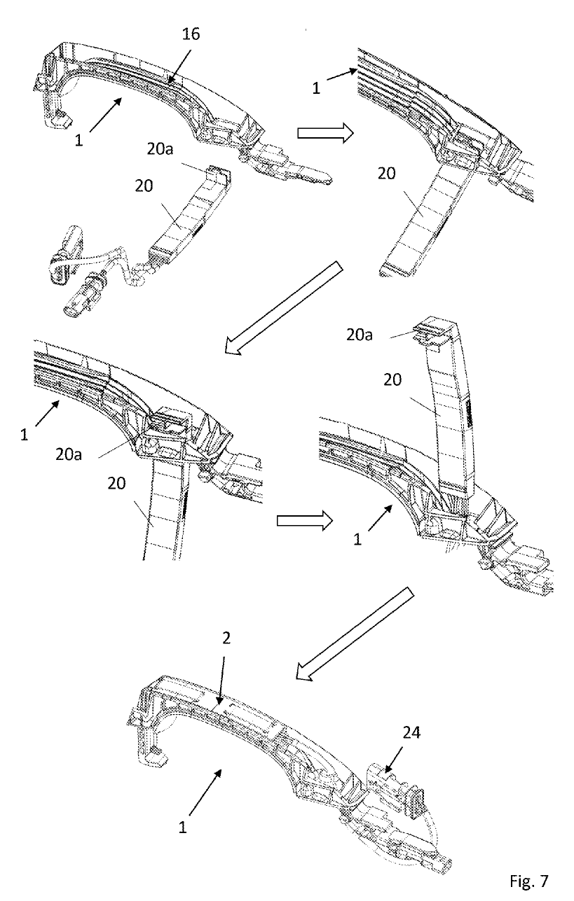

The steps required to assemble the grip member body and the sensor module are shown in FIG. 7.

The first step consists in approaching the head 20a of the casing 20 of the sensor module to the second side 10b of the body 1.

The second step consists in inserting the head 20a of the casing 20 of the sensor module 2 in the through opening 18, from the second side 10b of the body.

Once the head 20a of the casing 20 is inserted in the through opening 18, the third step consists in rotating the casing 20 of the sensor module 2 so the main part of the casing 20 is inserted in the through opening 18.

The fourth step consists in passing the whole casing 20 through the through opening 18, so that the casing 20 is located on the first side 10a of the body.

The fifth step consists in positioning the casing 20 within the recess 16 and connecting the head 20a of the casing 20 to the body 1 of the grip member

When the fifth step is completed, the sensor module 2 is assembled to the body 1 of the grip member. In this configuration, the wire harness 22 passes through the through opening 18 so that the connector 24 is located on the second side of the body 1 of the grip member.

Unless otherwise expressly indicated herein, all numerical values indicating mechanical/thermal properties, compositional percentages, dimensions and/or tolerances, or other characteristics are to be understood as modified by the word “about” or "approximately" in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A door handle assembly for a vehicle, comprising:
a grip member body; and
a sensor module, wherein:
the sensor module includes a casing in which at least one sensor is housed and a wire harness connecting the at least one sensor to an external connector, the casing of the sensor module an elongated shape along a longitudinal direction;
the grip member body includes a recess for receiving the casing of the sensor module, the recess being provided on a first side of the grip member body, the recess communicating with an opening provided on a second side of the grip member body opposite to the first side;
the opening is configured to allow the wire harness passing through the opening from one side of the grip member body to another;
the opening is further configured to allow inserting the casing of the sensor module and to prevent inserting the external connector.

2. The door handle assembly according to claim 1, wherein the recess provided in the grip member body has a generally rectangular shape.

3. The door handle assembly according to claim 2, wherein a length of the opening is greater than a width of the casing of the sensor module and is less than a width of the external connector of the sensor module.

4. The door handle assembly according to claims claim 3, wherein a width of the opening is greater than a thickness of the casing of the sensor module.

5. The door handle assembly according to claim 1, wherein the casing of the sensor module is secured to the grip member body by a detachable snap-in connection.

6. The door handle assembly according to claim 1, wherein a notch is provided in the vicinity of the opening to secure the wire harness of the sensor module.

7. A method for assembling the door handle assembly according to claim 1, comprising:
passing the casing of the sensor module and a part of the wire harness through the opening, from the second side of the grip member body to the first side;
locating the casing of the sensor module within the recess of a central portion of the grip member body.
